(19) United States
(12) Patent Application Publication
(10) Pub. No.: US 2010/0169321 A1
(43) Pub. Date: Jul. 1, 2010

(54) METHOD AND APPARATUS FOR CIPHERTEXT INDEXING AND SEARCHING

(75) Inventors: Liming Wang, Beijing (CN); Ye Tian, Beijing (CN); Toshikazu Fukushima, Beijing (CN); Hao Lei, Beijing (CN); Ke Zeng, Beijing (CN)

Correspondence Address: SUGHRUE MION, PLLC, 2100 PENNSYLVANIA AVENUE, N.W., SUITE 800, WASHINGTON, DC, 20037, US

(73) Assignee: NEC (China)Co., Ltd., Beijing (CN)

(21) Appl. No.: 12/636,493

(22) Filed: Dec. 11, 2009

(30) Foreign Application Priority Data
Dec. 30, 2008 (CN) 200810188850.3

(51) Int. Cl. G06F 17/30

(52) U.S. Cl. 707/741; 707/E17.049

(57) ABSTRACT

The present invention provides a method and apparatus for ciphertext indexing and searching. Indices of multiple levels are created for the encrypted files. Each item in the primary index includes a primary index item identifier and the ciphertext of the primary indexing information of the related file. The primary indexing information each includes an identifier(s) of the related secondary index item identifier(s) and the corresponding decryption information. Each item in the secondary index includes a secondary index item identifier and the ciphertext of the secondary indexing information. Information necessary for obtaining a file is included in the corresponding secondary indexing information. With the decryption information of the secondary indexing information in the decrypted primary indexing information, the ciphertext of the related secondary indexing information is decrypted so as to obtain information such as the decryption key of the file.

### FIELD OF THE INVENTION

The disclosure relates to information retrieval techniques, and more particularly to a method and apparatus for generating and using multi-level indices for ciphertext search.

### BACKGROUND

Storage outsourcing services and storage networking are topics of increasing commercial importance. In the face of information surge, many businesses are choosing to outsource their data storage and storage management. With data outsourcing services becomes increasingly popular; ciphertext search technique attracts much attention from researchers. However, the increasing complexity of storage technologies, the unending surge in data growth and the unprecedented importance of data security and business continuity bring difficulties to search techniques.

As an example, a ciphertext search technique called “ciphertext global search technology” is proposed by Xin Li in the Chinese patent application publication No. CN1588365A. In an encrypting phase, a user generates a key; querying keywords are encrypted with the key to generate a cipher index file; files are encrypted with the same key to generated encrypted files; then the user encrypts the key with a public key to generate an encrypted key; lastly, the cipher index file, the encrypted files and the encrypted key are stored to a ciphertext reservoir. In a searching phase, the encrypted key is downloaded from the ciphertext reservoir and is decrypted with a private key to obtain the key; a querying keyword is encrypted with the key to obtain an encrypted querying keyword; the encrypted querying keyword is transmitted to the ciphertext reservoir; lookup is performed in the cipher index file; a matching encrypted file is downloaded and decrypted with the key so as to obtain the plaintext of the file.

However, when the index needs to be updated, the existing methods have many drawbacks. In order to update an encrypted inverted index, the user must download files from the server, reconstruct the encrypted index and again upload the reconstructed index to the server, even if the contents of the files are not changed.

In addition, according to the method described above, whenever a file is moved or renamed, the storage server can observe the linkage between the keyword and the file, even if the keyword and the file are all encrypted. This implies a direct privacy breach. Second, the reason why the user downloads the file is to reconstruct the encrypted inverted index of file. This causes significant computation overhead. Third, the user uses a single key to encrypt all the files. File encryption in most cases utilizes stream cipher. However, encrypting more than one file with a single key is a well-known insecure approach. In addition, the user uses the same single key to encrypt all the files and all the keywords. Thus, it is possible that a searcher is able to retrieve all the files of the user after he/her searches on the files of the user with only one keyword. It is also considered insecure.

### SUMMARY OF THE INVENTION

The present invention provides a multi-level index which provides good security and privacy and enables easy and convenient updating.

In accordance with one aspect of the invention, an apparatus for ciphertext indexing is provided, comprising: a primary indexing unit configured to generate a primary index, in which each primary index item is related to a keyword and includes at least a primary index item identifier and a ciphertext of primary indexing information of each file related to said keyword; and a secondary indexing unit configured to generate one or more levels of secondary indices, in which each secondary index item includes at least a secondary index item identifier and a ciphertext of secondary indexing information, wherein each primary indexing information includes at least a secondary index item identifier and decryption information of secondary indexing information of an associated secondary index item of a first level, and each secondary indexing information includes at least decryption information of a ciphertext, or a secondary index item identifier and decryption information of secondary indexing information of an associated secondary index item of a next level.

In accordance with another aspect of the invention, a method for ciphertext indexing is provided, comprising: generating a primary index, in which each primary index item is related to a keyword and includes at least a primary index item identifier and a ciphertext of primary indexing information of each file related to said keyword; and generating one or more levels of secondary indices, in which each secondary index item includes at least a secondary index item identifier and a ciphertext of secondary indexing information, wherein each primary indexing information includes at least a secondary index item identifier and decryption information of secondary indexing information of an associated secondary index item of a first level, and each secondary indexing information includes at least decryption information of a ciphertext, or a secondary index item identifier and decryption information of secondary indexing information of an associated secondary index item of a next level.

In accordance with another aspect of the invention, an apparatus for ciphertext searching is provided, comprising: a primary search requesting unit configured to generate a primary search request including a primary index item identifier; a primary indexing information decrypting unit configured to decrypt a ciphertext of primary indexing information, which is received in response to the primary search request, to derive the primary indexing information; a secondary search requesting unit configured to generate a secondary search request according to a secondary index item identifier included in the primary indexing information; a secondary indexing information decrypting unit configured to decrypt a ciphertext of secondary indexing information, which is received in response to the secondary search request, with decryption information of secondary indexing information included in the primary indexing information; and a file retrieving unit configured to retrieve and decrypt a ciphertext of a file according to file retrieving information and a decryption key included in the primary indexing information and/or the secondary indexing information.

In accordance with another aspect of the invention, a method for ciphertext searching is provided, comprising: generating a primary search request including a primary index item identifier; receiving a ciphertext of primary indexing information; decrypting the ciphertext of primary indexing information to derive the primary indexing information; generating a secondary search request according to a secondary index item identifier included in the primary indexing information; receiving a ciphertext of secondary indexing information; decrypting the ciphertext of secondary indexing information with decryption information of secondary indexing information included in the primary indexing information; and retrieving and decrypting a ciphertext of a file according to file retrieving information and a decryption key included in the primary indexing information and/or the secondary indexing information.

In accordance with another aspect of the invention, an apparatus for ciphertext searching is provided, comprising: a primary search unit configured to search on a primary index for a matching primary index item according to a primary index item identifier and transmit a ciphertext of primary indexing information in the primary index item; and a secondary search unit configured to search on a secondary index for a matching secondary index item according to a secondary index item identifier and transmit a ciphertext of secondary indexing information in the secondary index item.

In accordance with another aspect of the invention, a method for ciphertext searching is provided, comprising: searching on a primary index for a matching primary index item according to a primary index item identifier; transmitting a ciphertext of primary indexing information in the primary index item; searching on a secondary index for a matching secondary index item according to a secondary index item identifier; and transmitting a ciphertext of secondary indexing information in the secondary index item.

### BRIEF DESCRIPTION OF THE DRAWINGS

The present invention will be better understood from the following detailed description of the preferred embodiments of the invention, taken in conjunction with the accompanying drawings in which like reference numerals refer to like parts and in which:

FIG. 1 is a diagram schematically illustrating an exemplary system;

FIG. 2 is a block diagram schematically illustrating an exemplary configuration of a user apparatus according to one embodiment of the invention;

FIG. 3 is a flow chart schematically illustrating the processes of generating a multi-level encrypted index according to one embodiment of the invention;

FIG. 4 is a block diagram schematically illustrating an exemplary configuration of a searcher apparatus according to one embodiment of the invention;

FIG. 5 is a block diagram schematically illustrating an exemplary configuration of a server according to one embodiment of the invention; and

FIG. 6 is a flow chart schematically illustrating a search process according to one embodiment of the invention.

### DESCRIPTION OF THE PREFERRED EMBODIMENTS

The features of various aspects of the invention and the exemplary embodiments will be described in detail below with reference to the drawings. In the following detailed description, numerous specific details are set forth to provide a full understanding of the present invention. It will be obvious, however, to one of ordinary skill in the art that the present invention may be put into practice without some of these specific details. The detailed description of the embodiments below is only for the purpose of better understanding of the invention by illustrating examples of the invention. The invention is never limited to any specific configuration and algorithm set forth below, but covers any modifications, alternatives and improvements of the elements, components and algorithms, as long as not departing from the spirit of the invention. In the drawings and the following description, well-known structures and techniques are not shown so as to avoid unnecessarily obscuring the present invention.

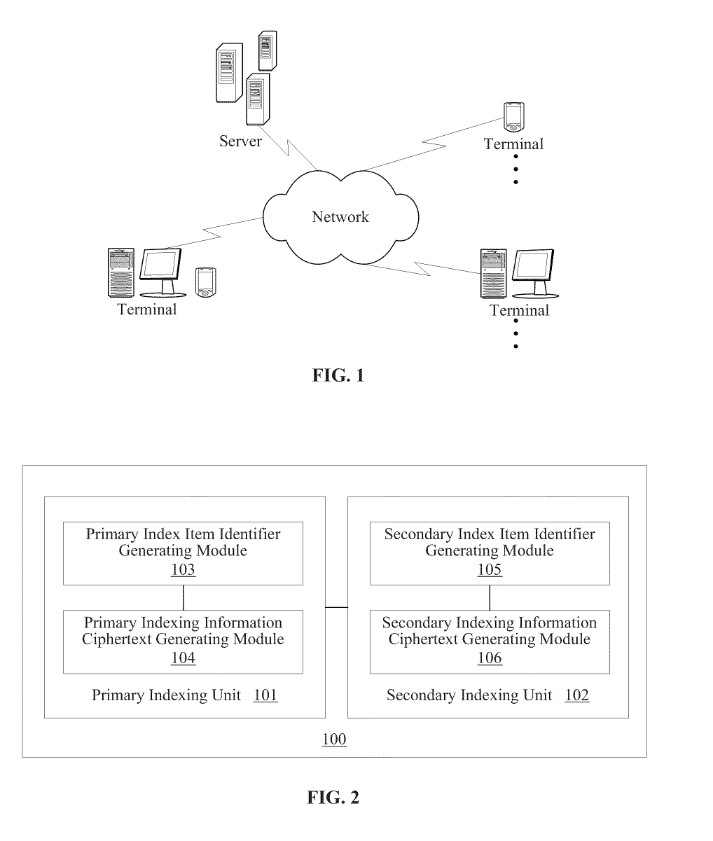

FIG. 1 schematically illustrates an exemplary system in which the invention may be applied. As shown in FIG. 1, one or a plurality of user terminals and one or a plurality of servers which provide storage services are communicable with each other via for example a network.

It should be noted that the term “server” as used throughout the description may be a single apparatus providing both storage and search services, or a set of multiple apparatus adjacent or remote to each other, each responsible for different services such as storage, data search, user management and the like, or sharing the burden of a service. For example, files are stored on a storage server(s), while indices are stored on a search server(s) which is communicable with the storage server(s). To simplify the description, all such apparatus are generally referred to as “server” in the description and drawings.

The server is generally implemented as a device or a set of devices capable of storing and maintaining data and enabling conditional access by the terminals to data, and managed by a service provider. The user terminal may be implemented as a device capable of processing and communicating information, for example, a personal computer (PC), a personal digital assistant (PDA), a smart mobile phone, a server or enterprise workstation manipulated by the user, or other data processing device. It should be noted that the particular implementations of the server device and the user device are not limited to any specific ones.

The network shown in FIG. 1 may be any kind of network, including any kind of telecommunication network or computer network. It can also comprise any internal data transfer mechanism, for example, a data bus or hub, when the respective devices are implemented as parts of a single apparatus.

Unlike the traditional ciphertext search techniques, the user makes a multi-level index for the encrypted filed to be stored on the server in the system according to the invention. In accordance with the result of search in a primary index, a corresponding item(s) in a secondary index is determined. Both of the primary index and the secondary index may be encrypted indices.

FIG. 2 schematically illustrates an exemplary configuration of a user apparatus 100 which generates and updates the index according to one embodiment of the invention. The user apparatus 100 may be any terminal device or any functional component(s) (implemented by hardware, firmware, software or any combination thereof) in a terminal device manipulate by the user.

As shown in FIG. 2, the user apparatus 100 mainly comprises a primary indexing unit 101 and a secondary indexing unit 102.

The primary indexing unit 101 is configured to generate the primary index. Each item in the primary index is associated with a keyword, and contains, at least, a primary index item identifier generated based on that keyword and a ciphertext of primary indexing information of each file related to that keyword. Accordingly, the primary indexing unit 101 may comprise, not excluding any other possible components, a primary index item identifier generating module 103 for generating primary index item identifiers, and a primary indexing information ciphertext generating module 104 for generating ciphertexts of primary indexing information.

The secondary indexing unit 102 is configured to generate a secondary index or multiple levels of secondary indices. Each item in the primary index may relate to a file and contains, at least, a secondary index item identifier and a ciphertext of secondary indexing information related in acquisition of the corresponding file. Accordingly, the secondary indexing unit 102 may comprise, not excluding any other possible components, a secondary index item identifier generating module 105 for generating secondary index item identifiers, and a secondary indexing information ciphertext generating module 106 for generating ciphertexts of secondary indexing information.

In the multi-level index according to the invention, each primary indexing information may include, at least, a secondary index item identifier of an associated secondary index item, and decryption information necessary for decrypting that secondary index item. Each secondary indexing information may include at least decryption information necessary for decrypting the ciphertext of the file, or in the case that that there is an associated secondary index of a next level, includes at least the secondary index item identifier of that associated secondary index of the next level and decryption information necessary for decrypting the secondary indexing information of the associated secondary index item of the next level. According to different embodiments, information of a file path or a ciphertext name of the file for retrieving the encrypted file may be included in the primary indexing information or the secondary index information.

Assuming that there are n files Fileᵢ (i=1, . . . , n) related to a key work KW (e.g. the files including this keyword), an item associated with the keyword KW in the primary index may take the form as follow

<PID_{kw}:E(Info_P₁, key_P₁); . . . ; E(Info_Pᵢ, key_Pᵢ); . . . E(Info_Pₙ, key_Pₙ)> (Expression 1)

where PID_{kw} is the primary index item identifier related to the keyword KW; Info_Pᵢ is the primary indexing information of the i^{th} file Fileᵢ (i=1, . . . , n) related to the keyword KW; key_Pᵢ is a key for encrypting Info_Pᵢ; and E(A, B) denotes encrypting A with the key B.

It should be noted that primary indexing information of different files in a primary index item may be encrypted with the same key. Alternatively, primary indexing information of different files in a primary index item may be encrypted with different keys. In the case that primary indexing information of different files in a primary index item share the same key, the primary index item may be in an alternative form as follow:

<PID_{kw}:E(Info_P₁∥ . . . ∥Info_Pᵢ∥ . . . , key_P)> (Expression 2)

that is, the primary indexing information of all the files related to the keyword KW are encrypted with the key key_Pᵢ.

It should be noted that the primary indexing information in several or all primary index items may be encrypted with the same key. However, for the primary index items corresponding to different keywords, it is preferable to take different keys to encrypt the respective primary indexing information so as to provide enhanced security.

The above described primary index item identifier PID_{kw} may be, for example, the ciphertext of the keyword KW. As an example, PID_{kw}=E(KW, sk). sk is a key for encrypting the keyword, which may be a user's secret key or other key. Preferably, the key for generating the primary index item identifier PID_{kw} is different from the key for generating the ciphertext of the primary indexing information. It should be noted that PID_{kw} may be generated in other manners, as long as different keywords correspond to different PID_{kw}.

The primary indexing information Info_Pᵢ of the file Fileᵢ at least includes an identifier of a secondary index item related to acquisition of that file, and information necessary for decrypting the ciphertext of the secondary indexing information in that secondary index item, for example, a decryption key. Info_Pᵢ may include other information. For example, in some embodiments, Info_Pᵢ may further include information for verifying decryption of the primary indexing information. In some embodiments, Info_Pᵢ may further include information about the file Fileᵢ. In addition, some information required in acquiring the file Fileᵢ may be also included in the primary indexing information Info_Pᵢ.

There may be only one secondary index or multiple levels of secondary indices. As a general expression, an item, which is related to an arbitrary file Fileᵢ, in a secondary index of the j^{th} level, may take the form as follow:

<VIDₖ^{(j)}:E(Info_Sₖ^{(j)}, key_Sₖ^{(j)})> (Expression 3)

where VIDₖ^{(j)} is the secondary index item identifier of this secondary index item; Info_Sₖ^{(j)} is the secondary indexing information of this secondary index item; and key_Sₖ^{(j)} is a key for encrypting the secondary indexing information. It should be noted that keys for encrypting secondary indexing information of different secondary index items may be different.

The secondary index item identifier VIDₖ^{(j)} may be calculated by any algorithm as long as the secondary index item identifiers of secondary index items related to different files are different from each other, and the user can reproduce VIDₖ^{(j)} from information of the file. For example, the secondary index item identifier VIDₖ^{(j)} may be an unique identifier of the file Fileₖ.

If multiple levels of secondary indices are employed and a secondary index of a next level is to be accessed in order to acquire full information about the file Fileₖ, the above described secondary indexing information Info_Sₖ^{(j)} includes, at least, the secondary index item identifier of the associated secondary index of the next level and information necessary for decrypting the secondary indexing information of the associated secondary index item of the next level. All or part of information necessary for acquiring the file Fileₖ may be included in the secondary indexing information of the secondary index item identifier of the last level, or distributed in the secondary indexing information of the secondary index items of several levels.

If there is only one level of secondary index item, the above described secondary indexing information Info_Sₖ^{(j)} (j=1) includes at least all or part of information necessary for acquiring the file Fileₖ.

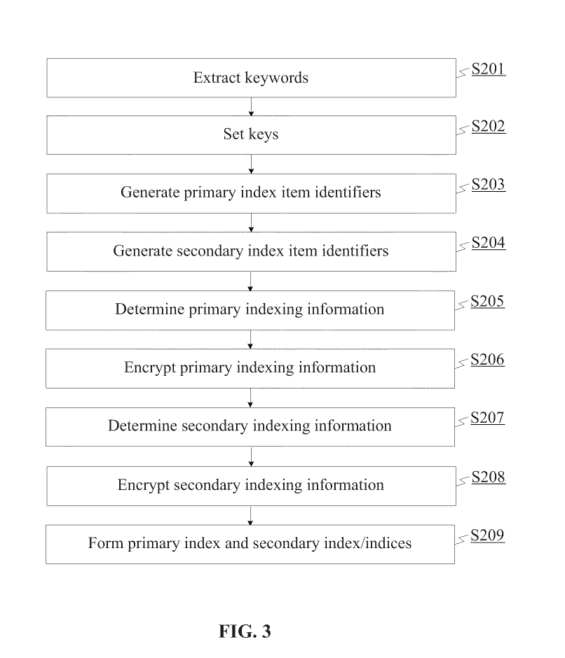

FIG. 3 schematically illustrates the processes of generating a multi-level encrypted index according to one embodiment of the invention.

First, the user apparatus 100 makes initial settings, for example, extracting and summarizing the keywords of the files at step S201 and setting respective keys necessary for generating the index at step S202, e.g. keys for encrypting the primary indexing information and the secondary indexing information and optionally keys for generating the primary index item identifiers and the secondary index item identifiers in some embodiments, as well as the related decryption keys. The above processes may be performed for example by an initialization unit or other unit in the user apparatus 100. Since the keywords may be extracted by any conventional method and various keys may be set by any conventional cryptology system, the detailed description of the related components and processes are omitted to avoid unnecessarily obscuring the present invention. It should be noted that in the system of the invention, either symmetric cryptology or asymmetric cryptology may be used. Alternatively, symmetric cryptology and asymmetric cryptology are used in a composite manner in the multi-level encrypted index. For example, symmetry cryptology is applied to some of information and asymmetric cryptology is applied to others.

At step S203, the primary indexing unit 101 generates the primary index item identifiers of the primary index items related to each keywords by the primary index item identifier generating module 103. For example, a primary index item identifier is generated by encrypting the keyword or information containing the keyword with a user's secret key.

At step S204, the secondary indexing unit 102 generates the secondary index item identifiers of the secondary index items related to each files by the secondary index item identifier generating module 105. For example, an unique identifier of a the file is calculated as the identifier of the associated secondary index item.

At step S205, the primary indexing unit 101 determines primary indexing information for each primary index item and encrypts the primary indexing information at step S206 by the primary indexing information ciphertext generating module 104. As described above, for the primary indexing information related to different keywords, the different respective keys may be used for encryption.

At step S207, the secondary indexing unit 102 determines secondary indexing information for each secondary index item and encrypts the secondary indexing information at step S208 by the secondary indexing information ciphertext generating module 106. As described above, for the secondary indexing information in different secondary index items, the different respective keys may be used for encryption.

At step S209, the primary indexing unit and the secondary indexing unit forms the primary index and the secondary index/indices, respectively.

In order to provide better understanding of the invention, several examples of particular multi-level encrypted index are provided below. It should be noted that these examples are only for the illustrational purpose and the essence of the invention is never limited to any particular algorithms and configurations described.

To be concise, an example of a two-level encrypted index (one level of primary index and one level of secondary index) is provided below first. In the following example, it is assumed that n files Fileᵢ (i=1, . . . , n) are related to a keyword KW (e.g. the files including the keyword), and the primary index may be in the form of the above Expression 1 or 2 and the secondary index may be in the form of the above Expression 3.

### Example 1

In a primary index item associated with the keyword KW, the primary indexing information Info_Pᵢ for file Fileᵢ is generated as follow:

Info_{—}Pᵢ=(flag∥pathᵢ∥CFNᵢ∥PFNᵢ∥VIDᵢ∥Key_VIDᵢ) (Expression 4)

where flag is flag information for verifying correctness of decryption of the primary indexing information, pathᵢ is the access path of the ciphertext of Fileᵢ, CFNᵢ is the ciphertext file name of Fileᵢ, PFNᵢ is the plaintext file name of Fileᵢ, VIDᵢ is the secondary index item identifier of a secondary index item associated with Fileᵢ, and Key_VIDᵢ is a secondary indexing information decryption key for decrypting the ciphertext of the secondary indexing information in this secondary index item. It should be noted that the decryption key Key_VIDᵢ is the same as the key key_Sᵢ^{(j)} in the above Expression 3 if a symmetric cryptology is employed.

In this example, a secondary index item associated with a file Fileₖ is

<VIDₖ:E(Info_Sₖ, key_Sₖ)> (Expression 5)

where the secondary indexing information Info_Sₖ is generated as follow:

Info_{—}Sₖ=(flag∥fkeyₖ) (Expression 6)

where flag is flag information for verifying correctness of decryption of the secondary indexing information, and fkeyₖ is a file decryption key for decrypting the ciphertext of the file fkeyₖ.

In this example, the secondary index item identifier VIDₖ may be, for example, simply a sequential or random identification number of the file Fileₖ, or any other arbitrary value unique to the file Fileₖ.

According to the multi-level encrypted index of this example, by looking up the primary index with a primary index item identifier, a matching primary index item is found. Then, the file path, the ciphertext file name and the plaintext file name of each file related to the corresponding keyword, as well as the related secondary index item identifiers and the corresponding secondary indexing information decryption keys, are obtained by decrypting the primary indexing information in this primary index item. After getting the above information, the secondary index may be further searched by using each of the obtained the secondary index item identifiers to retrieve the respective matching secondary index items. Then, the ciphertext of the secondary indexing information in each matching secondary index item is decrypted with the respective secondary indexing information decryption key so as to obtain the file decryption key of the related file. With the information obtained above, the plaintexts of each files related to the queried keyword can be obtained.

The use of flag is explained below. As an example, flag may be a value known to the searcher in advance. When decrypting the ciphertext of information including the flag flag (e.g. decrypting the ciphertext of the primary index item identifier or the secondary indexing information in this example), the searcher may determine whether the decryption is correct by checking whether a corresponding flag′ in the decrypted information is consistent with the known flag. In the case that the searcher receives the ciphertext of plural pieces of primary indexing information or secondary indexing information originally encrypted with different keys, the flag can be used to help the searcher to determine which information is decryptable and which is not for the searcher. Accordingly, by encrypting different information with different keys (for example, encrypting different primary indexing information in the same primary index item) and issuing to a searcher one of or a part of the single decryption keys, the rights of searchers are differentiated and controlled.

It is obvious that flag is a kind of auxiliary information and is not necessary for some applications where verification of decryption is not needed or other kind of verification is employed.

### Example 2

In this example, the primary indexing information in the above Example 1 is replaced with

Info_{—}Pᵢ=(flag∥VIDᵢ∥Key_VIDᵢ) (Expression 7)

and the secondary indexing information in the above Example 1 is replaced with

Info_{—}Sₖ=(pathₖ∥CFNₖ∥PFNₖ∥fkeyₖ) (Expression 8)

According to the multi-level encrypted index of this example, the identifiers of the secondary index items for every related files and the corresponding secondary indexing information decryption keys can be obtained by searching in the primary index and the corresponding decryption. Then, the file path, the ciphertext file name, the plaintext file name and the file decryption key of each related file can be obtained by searching in the secondary index and the corresponding decryption, so that the plaintexts of the files can be obtained.

In this example, the secondary index item identifier VIDₖ of the secondary index item related to an arbitrary file Fileₖ may be generated as follow:

VIDₖ=hash(fparaₖ, sk) (Expression 9)

where hash is a hash function; fparaₖ is a content of a certain section, for example, the first sentence or paragraph or the last sentence or paragraph and the like, in the file Fileₖ; and sk is the user's secret key or other secret information.

### Example 3

This example is similar to the above Example 2, except for that the secondary index item identifier VIDₖ of the secondary index item related to a file Fileₖ is replaced with

VIDₖ=hash(CFNₖ, sk) (Expression 10)

where CFNₖ is the ciphertext file name of the file Fileₖ.

### Example 4

This example is similar to the above Example 2 and Example 3, except for that the secondary index item identifier VIDₖ of the secondary index item related to a file Fileₖ is replaced with

VIDₖ=PRF(seed) (Expression 11)

where PRF is a pseudorandom number function and seed) is a random input to the function.

In this example, the user may keep the correspondence relation between each secondary index item identifier and the corresponding file for the use of later updating. For example, the following mapping or table is stored:

<VIDₖ:CFNₖ> (Expression 12)

Several examples of particular two-level encrypted index are provided above. It would be appreciated that any number of levels of encrypted index may be designed. For the purpose of better understanding, an example of a three-level encrypted index is provided below in which one level of primary index and two levels of secondary indices are used.

### Example 5

In a primary index item associated with the keyword KW, the primary indexing information Info_Pᵢ related to a file Fileᵢ is generated as follow:

Info_{—}Pᵢ=(flag∥VIDᵢ⁽¹⁾∥Key_VIDᵢ¹) (Expression 13)

where VIDᵢ⁽¹⁾ is the secondary index item identifier of the secondary index item of the first level that is associated with the file Fileᵢ, and Key_VIDᵢ⁽¹⁾ is a secondary indexing information decryption key for decrypting the secondary indexing information in this first-level secondary index item.

A secondary index item of the first level that is associated with an arbitrary file Fileₖ is

<VIDₖ⁽¹⁾:E(Info_Sₖ⁽¹⁾, key_Sₖ⁽¹⁾)> (Expression 14)

where the secondary indexing information Info_Sₖ⁽¹⁾ is generated as follow:

Info_{—}Sₖ⁽¹⁾=(flag∥pathₖ∥CFNₖ∥VIDₖ⁽²⁾∥Key_VIDₖ⁽²⁾) (Expression 15)

where VIDₖ⁽²⁾ is the secondary index item identifier of the secondary index item of the second level that is associated with the file Fileₖ, and Key_VIDₖ⁽²⁾ is a secondary indexing information decryption key for decrypting the secondary indexing information in this second-level secondary index item.

A secondary index item of the second level that is associated with an arbitrary file Fileₖ is

<VIDₖ⁽²⁾:E(Info_Sₖ⁽²⁾, key_Sₖ⁽²⁾)> (Expression 16)

where the secondary indexing information Info_Sₖ⁽²⁾) is generated as follow:

Info_{—}Sₖ⁽²⁾=(flag∥PFNₖ∥fkeyₖ) (Expression 17)

In this example, the secondary index item identifier VIDₖ⁽¹⁾ of the first level and the secondary index item identifier VIDₖ⁽²⁾ of the second level may be designated in any manner, as long as identifiability are ensured for each index item.

According to the three-level encrypted index of this example, the secondary index item identifiers of the first level for the respective related files and the corresponding secondary indexing information decryption keys of the first level can be obtained by searching in the primary index and the corresponding decryption. Then, by searching in the secondary index of the first level with the obtained one or more secondary index item identifiers of the first level and by the corresponding decryption(s) with the corresponding secondary indexing information decryption key(s) of the first level, the file path and the ciphertext file name of each related file as well as the secondary index item identifier of the related second-level secondary index item and the corresponding secondary indexing information decryption key of the second level can be obtained. After that, by searching and decryptions in the secondary index of the second level with the obtained one or more secondary index item identifiers of the second level and the corresponding secondary indexing information decryption key(s) of the second level, the plaintext file name and the file decryption key of each related file can be obtained and thereby all information necessary for obtaining the plaintexts of the files are achieved

In the above example, each item in the secondary indices of the two levels is configured with respect to the file to be retrieved. However, it would be appreciated that information indexed in the secondary indices are not limited to these. For example, the file decryption keys for acquiring the corresponding files may be indexed in the secondary index of the first level, while additional information are indexed in the secondary index of the second level, for example, each secondary index item of the second level is related to information of a reference document. In such case, the secondary indexing information in the secondary index item of the first level may contain one or more secondary index item identifiers of the second level and the decryption keys corresponding to the related reference documents. In addition, it would be appreciated that the number of levels of the secondary index may be set arbitrarily and one or more kinds of information may be indexed in each level.

In the above examples, the access path of the file, the ciphertext file name, the plaintext file name, the flag for verification of decryption and the decryption key of the file are taken as information of a file, which are indexed in the encrypted index. However, these information may be unnecessary for some applications. For example, if retrieval of an encrypted file on a server is enabled by providing either of the access path or the ciphertext file name, the access path is not necessary or the ciphertext file name is not necessary. And, in some implementations, the plaintext file name or the verification flag is not necessary. In addition, it would be appreciated that the information which can be indexed in the index are not limited to the above described contents. Any information may be added as required depending on the particular applications. The information may be incorporated in secondary indexing information of several levels in a distributive manner, or a part of them are included in the primary indexing information.

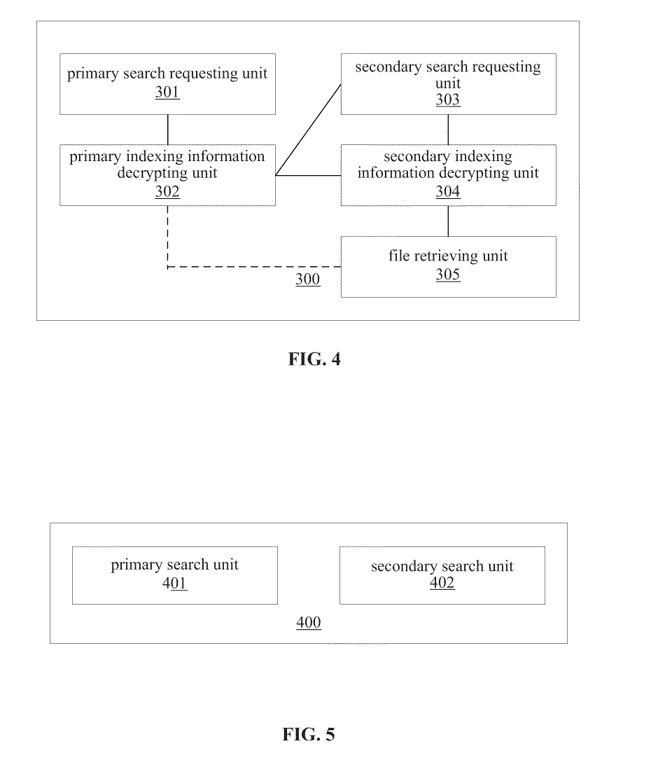

The use of the multi-level encrypted index according to one embodiment is described below with reference to FIGS. 4-6.

FIG. 4 schematically illustrates an exemplary configuration of a searcher apparatus according to one embodiment of the invention.

As shown in FIG. 4, the searcher apparatus 300 mainly comprises a primary search requesting unit 301 for generating a primary search request, a primary indexing information decrypting unit 302 for decrypting the ciphertext of the primary indexing information, a secondary search requesting unit 303 for generating a secondary search request, a secondary indexing information decrypting unit 304 for decrypting the ciphertext of the secondary indexing information and a file retrieving unit 305 for retrieving and decrypting the ciphertext of the file.

FIG. 5 schematically illustrates an exemplary configuration of a search server according to one embodiment of the invention.

As shown in FIG. 5, the server 400 is adapted to perform search on the multi-level index, and mainly comprises a primary search unit 401 for perform search in the primary index and a secondary search unit 402 for performing search in the secondary index. The server 400 may also include a file search unit for searching encrypted filed if the encrypted files are also stored on the server 400.

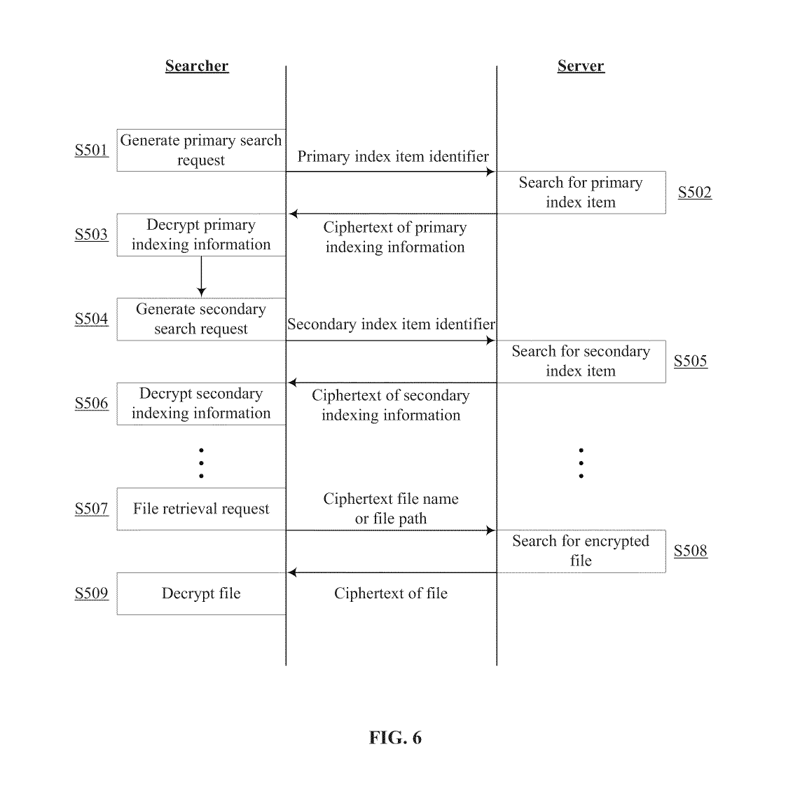

FIG. 6 schematically illustrates the search process according to one embodiment of the invention. The left part of FIG. 6 shows the operations at the searcher terminal, and the right part of FIG. 6 shows the operations at the storage and search server.

Before the search, the searcher shall firstly get authorized for search. For example, the searcher obtains from the file owner or other party a primary index item identifier corresponding to a keyword authorized to be searched, and obtains the corresponding primary indexing information decryption key for decrypting the primary indexing information. Alternatively, the searcher obtains related information and derives the primary index item identifier and the corresponding decryption key via some kind of computation. The searcher terminal may perform any necessary authorization process in order to obtain such initial information. It is conceivable that the searcher described below may be the data owner itself/himself/herself.

At the time of searching, the primary search requesting unit 301 of the searcher terminal generates a primary search request at step S501 firstly, the primary search request including a primary index item identifier obtained or computed by the searcher. Then, the searcher terminal transmits the primary search request to the server.

The server receives the primary search request and at step S502, the primary search unit 401 of the server performs search in the primary index stored in the server to find the primary index item whose primary index item identifier conforms to the received primary index item identifier in the request. After that, the server returns the ciphertext of the primary indexing information included in the matching primary index item to the searcher terminal. Optionally, the server may perform necessary authentication on the searcher before the search.

After receiving the ciphertext of the primary indexing information, the primary indexing information decrypting unit 302 of the searcher terminal decrypts the received ciphertext of the primary indexing information at step 503 with the primary indexing information decryption key obtained in advance so as to derive each secondary index item identifier and the corresponding secondary indexing information decryption key corresponding to each related file. In addition, other information may be got from the primary indexing information. For example, in the situation of the above Example 1, the ciphertext file names or file paths of the related files are also obtained.

At step S504, the secondary search requesting unit 303 of the searcher terminal generates a secondary search request. The secondary search request may include one or more secondary index item identifiers obtained above. Then, the searcher terminal transmits the secondary search request to the server.

After receiving the secondary search request, the secondary search unit 402 of the server performs search in the secondary index stored in the server at step S505 to find each secondary index item(s) whose secondary index item identifier(s) conforms to the secondary index item identifier(s) in the secondary search request. After that, the server returns the respective ciphertext of the secondary indexing information included in each matching secondary index item to the searcher terminal.

After receiving the ciphertext(s) of the secondary indexing information, the secondary indexing information decrypting unit 304 of the searcher terminal decrypts the received ciphertext(s) of the secondary indexing information at step S506 with the corresponding secondary indexing information decryption key(s) obtained, so as to derive the corresponding secondary indexing information.

In the case that there is only one level of secondary index, the searcher terminal has got hereto from the decrypted secondary indexing information (and the decrypted primary indexing information) all necessary information for obtaining the files. Of course, the searcher terminal would also get other information included in the primary indexing information and the secondary indexing information if any.

If the case that there are two or more levels of secondary indices, the searcher terminal would obtain the secondary index item identifier(s) of the next level and the corresponding decryption key(s) from the current decrypted secondary indexing information. Then, the processes from S504 to S506 are repeated till the searcher terminal obtains all necessary information in the index of each level.

Then, at step 507, the file retrieving unit 305 of the searcher terminal generates a file retrieval request for the related file(s) based on the obtained information. The file retrieval request includes for example the ciphertext file name or the access path of the file, or other information based on which the encrypted file may be determined uniquely. After that, the searcher terminal transmits the file retrieval request to the server which stores the files (in an implementation, the file storage server and the search server may be the same one).

At step S508, the file storage server searches for the requested encrypted file(s) by for example a file search unit based on the information provided by the searcher terminal, and provides the matching encrypted file(s) to the searcher terminal.

Alternatively, in another implementation, the searcher terminal retrieves the encrypted file(s) from a corresponding storage location(s) based on the access path(s) of the file(s).

After getting the ciphertext of each related file, the file retrieving unit 305 of the searcher terminal decrypts the ciphertext of the file with the corresponding decryption key obtained form the secondary indexing information (or primary indexing information) so as to get the plaintext of each file.

In the case that the indexing information includes the flag flag for verifying the decryption, the primary indexing information decrypting unit, the secondary indexing information decrypting unit or the file retrieving unit, for example, may check whether the flag obtained from the decrypted information is the same as the predetermined flag flag that is known in advance, in the decryption processes described above. If it is, the decryption is indicated correct. Otherwise, the decryption is incorrect. According to the result of the verification, the searcher may select proper information and discard information that cannot be decrypted correctly.

The above process is only a particular example. The invention is never limited to any particular step or the sequence of the steps described above. For example, the steps S507 and S508 may be performed even earlier if the ciphertext file name of the file has been obtained before completion of decryption of all secondary indexing information of all levels (for example, a situation in the above Example 1).

According to the multi-level encrypted index and search process of the invention, the contents of the stored encrypted files as well as the association between the keywords and the files will not be revealed to the server. By encryption with different keys, enhanced security and privacy are provided, authorized decryption of files is prevented and leakage of privacy in the traditional ciphertext search techniques is avoided.

In addition, according to the multi-level index of the invention, a more flexible update of the index can be provided. Briefly speaking, when the secondary index is to be updated due to changes in the files, it can simply update the related secondary index items with the help of the secondary index item identifiers, and in some situations, the primary index may be kept unchanged.

For example, in the above Examples 2, 3 and 4, if a location of a file is changed, the user apparatus may simply calculate the corresponding secondary index item identifier and the ciphertext of the corresponding updated secondary indexing information, and transmit them to the server. This process may be performed for example by the secondary indexing unit of the user apparatus, or by an updating unit additionally configured. The server identifies the corresponding secondary index item by the received secondary index item identifier, updates the ciphertext of the secondary indexing information therein with the updated ciphertext of the secondary indexing information received from the user apparatus, while the primary index does not need to be changed. This process may be performed by an updating unit additionally configured in the server.

And, in the above Examples 2 and 4, the secondary index item identifier is not generated from the file name. Thus, even if a file is renamed, the corresponding secondary index item may be identified with the corresponding secondary index item identifier, and the ciphertext of the secondary indexing information therein may be updated so as to implement the correction, while the primary index does not need to be changed.

Depending on the kind of information indexed in the primary and secondary indices and the method of generating the index item identifiers, a corresponding updating method is adopted. It is possible that only one level of the index is updated or some particular index item in the index is updated, since the index is divided into indices configured in multiple levels.

Some particular embodiments according to the invention have been described above with reference to the drawings. However, the invention is not intended to be limited by any particular configurations and processes described in the above embodiments. Those skilled in the art may conceive of various alternatives, changes or modifications of the above-mentioned configurations, algorithms, operations and processes within the scope of the spirit of the invention.

The term “file” as mentioned throughout the description should be interpreted as a broad concept, and it includes, but not limited to, for example, text file, video/audio file, pictures/charts, and any other data or information.

The term “keyword” as mentioned throughout the description should be interpreted as a broad concept, and it includes any data or information related to a particular file(s).

As exemplary configurations of the data owner terminal, the searcher terminal and the server, some units coupled together have been shown in the drawings. These units can be coupled via a bus or any other signal lines, or by any wireless connection, to transfer signals therebetween. However, the components included in each apparatus are not limited to those units described, and the particular configurations may be modified or changed. Each apparatus may further comprise other units, such as a display unit for displaying information to the operator of the apparatus, an input unit for receiving the input of the operator, a controller for controlling the operation of each unit, a communication unit and interface for communications, any necessary storage or processing means, etc. They are not described in detail since such components are known in the art, and a person skilled in the art would easily conceive of adding them to any apparatus described above. In addition, although the described units are shown in separate blocks in the drawings, any of them may be combined with the others as one component, or be divided into several components.

Further, data owner terminal, searcher terminal and the server are described and shown as separate apparatus in the above examples, which may be positioned remotely with each other in a communication network. However, they can be combined as one apparatus for enhanced functionality. For example, the data owner terminal and the searcher terminal could be combined to create a new apparatus that is data owner terminal in some cases while capable of performing search as a searcher terminal in some other cases. For another example, the server and the data owner terminal or the searcher terminal could be combined if it acts these two roles in an application. Also, an apparatus may be created to act as data owner terminal, searcher terminal and server in different transactions.

The elements of the invention may be implemented in hardware, software, firmware or a combination thereof and utilized in systems, subsystems, components or sub-components thereof. When implemented in software, the elements of the invention are programs or the code segments used to perform the necessary tasks. The program or code segments can be stored in a machine-readable medium or transmitted by a data signal embodied in a carrier wave over a transmission medium or communication link. The “machine-readable medium” may include any medium that can store or transfer information. Examples of machine-readable medium include an electronic circuit, a semiconductor memory device, a ROM, a flash memory, an erasable ROM (EROM), a floppy diskette, a CD-ROM, an optical disk, a hard disk, a fiber optic medium, a radio frequency (RF) link, etc. The code segments may be downloaded via computer networks such as the Internet, Intranet, etc.

The invention may be embodied in other specific forms without departing from the spirit or essential characteristics thereof. The present embodiments are therefore to be considered in all respects as illustrative and not restrictive, the scope of the invention is indicated by the appended claims rather than by the foregoing description, and all changes which come within the meaning and range of equivalency of the claims are therefore intended to be embraced therein.

What is claimed is:

1. An apparatus for ciphertext indexing, comprising:
a primary indexing unit configured to generate a primary index, in which each primary index item is related to a keyword and includes at least a primary index item identifier and a ciphertext of primary indexing information of each file related to said keyword; and
a secondary indexing unit configured to generate one or more levels of secondary indices, in which each secondary index item includes at least a secondary index item identifier and a ciphertext of secondary indexing information,
wherein each primary indexing information includes at least a secondary index item identifier and decryption information of secondary indexing information of an associated secondary index item of a first level, and each secondary indexing information includes at least decryption information of a ciphertext, or a secondary index item identifier and decryption information of secondary indexing information of an associated secondary index item of a next level.

2. The apparatus according to claim 1, wherein the primary indexing information of each file further includes one or more of a path of the file, a ciphertext name of the file, a plaintext name of the file and a flag for verifying decryption.

3. The apparatus according to claim 1, wherein the secondary indexing information in at least one level secondary index further includes one or more of a path of an associated file, a ciphertext name of the associated file, a plaintext name of the associated file and a flag for verifying decryption.

4. The apparatus according to claim 1, wherein the primary indexing unit comprises a primary index item identifier generating module configured to generate the primary index item identifier and a primary indexing information ciphertext generating module configured to determine the primary indexing information and generate the ciphertext of the primary indexing information, and the secondary indexing unit comprises a secondary index item identifier generating module configured to generate the secondary index item identifier and a secondary indexing information ciphertext generating module configured to determine the secondary indexing information and generate the ciphertext of the secondary indexing information.

5. The apparatus according to claim 1, wherein the secondary index item identifier of the secondary index of the first level is a unique identifier of the file.

6. The apparatus according to claim 1, wherein the secondary index item identifier is one of a serial number of the file, a hash value of information including a part of content of the file, a hash value of information including a ciphertext name of the file, and a value in a mapping table.

7. The apparatus according to claim 1, wherein the secondary indexing unit is further configured to generate, when a file is updated, an updated ciphertext of secondary indexing information for replacing the ciphertext of secondary indexing information in the related secondary index item.

8. The apparatus according to claim 1, wherein the ciphertext of primary indexing information and the primary index item identifier are generated with different keys.

9. The apparatus according to claim 1, wherein decryption keys for ciphertexts of primary indexing information in different primary index items are different from each other.

10. The apparatus according to claim 1, wherein decryption keys for ciphertexts of secondary indexing information in different secondary index items are different from each other.

11. A method for ciphertext indexing, comprising:
generating a primary index, in which each primary index item is related to a keyword and includes at least a primary index item identifier and a ciphertext of primary indexing information of each file related to said keyword; and
generating one or more levels of secondary indices, in which each secondary index item includes at least a secondary index item identifier and a ciphertext of secondary indexing information,
wherein each primary indexing information includes at least a secondary index item identifier and decryption information of secondary indexing information of an associated secondary index item of a first level, and each secondary indexing information includes at least decryption information of a ciphertext, or a secondary index item identifier and decryption information of secondary indexing information of an associated secondary index item of a next level.

12. The method according to claim 11, wherein the primary indexing information of each file further includes one or more of a path of the file, a ciphertext name of the file, a plaintext name of the file and a flag for verifying decryption.

13. The method according to claim 11, wherein the secondary indexing information in at least one level secondary index further includes one or more of a path of an associated file, a ciphertext name of the associated file, a plaintext name of the associated file and a flag for verifying decryption.

14. The method according to claim 11, wherein generating the secondary indices comprises determining a unique identifier of a file as the corresponding secondary index item identifier of the secondary index of the first level.

15. The method according to claim 11, wherein the secondary index item identifier is one of a serial number of the file, a hash value of information including a part of content of the file, a hash value of information including a ciphertext name of the file, and a value in a mapping table.

16. The method according to claim 11, further comprising generating, when a file is updated, an updated ciphertext of secondary indexing information for replacing the ciphertext of secondary indexing information in the related secondary index item.

17. The method according to claim 11, wherein the ciphertext of primary indexing information and the primary index item identifier are generated with different keys.

18. The method according to claim 11, wherein ciphertexts of primary indexing information in different primary index items are generated with different keys.

19. The method according to claim 11, wherein ciphertexts of secondary indexing information in different secondary index items are generated with different keys.

20. An apparatus for ciphertext searching, comprising:
a primary search requesting unit configured to generate a primary search request including a primary index item identifier;
a primary indexing information decrypting unit configured to decrypt a ciphertext of primary indexing information, which is received in response to the primary search request, to derive the primary indexing information;
a secondary search requesting unit configured to generate a secondary search request according to a secondary index item identifier included in the primary indexing information;
a secondary indexing information decrypting unit configured to decrypt a ciphertext of secondary indexing information, which is received in response to the secondary search request, with decryption information of secondary indexing information included in the primary indexing information; and
a file retrieving unit configured to retrieve and decrypt a ciphertext of a file according to file retrieving information and a decryption key included in the primary indexing information and/or the secondary indexing information.

21. The apparatus according to claim 20, wherein
the secondary search requesting unit is further configured to generate a next-level secondary search request according to a secondary index item identifier of a next level included in the secondary indexing information; and
the secondary indexing information decrypting unit is further configured to decrypt a ciphertext of secondary indexing information of the next level, which is received in response to the next-level secondary search request, with decryption information of the next level secondary indexing information included in said secondary indexing information.

22. The apparatus according to claim 20, wherein the primary indexing information decrypting unit verifies decryption in accordance with a flag included in the primary indexing information.

23. The apparatus according to claim 20, wherein the secondary indexing information decrypting unit verifies decryption in accordance with a flag included in the secondary indexing information.

24. A method for ciphertext searching, comprising:
generating a primary search request including a primary index item identifier;
receiving a ciphertext of primary indexing information;
decrypting the ciphertext of primary indexing information to derive the primary indexing information;
generating a secondary search request according to a secondary index item identifier included in the primary indexing information;
receiving a ciphertext of secondary indexing information;
decrypting the ciphertext of secondary indexing information with decryption information of secondary indexing information included in the primary indexing information; and
retrieving and decrypting a ciphertext of a file according to file retrieving information and a decryption key included in the primary indexing information and/or the secondary indexing information.

25. The method according to claim 24, further comprising:
generating a next-level secondary search request according to a secondary index item identifier of a next level included in the secondary indexing information; and
decrypting a ciphertext of secondary indexing information of the next level with decryption information of the next level secondary indexing information included in said secondary indexing information.

26. The method according to claim 24, further comprising verifying decryption in accordance with a flag included in the primary indexing information.

27. The method according to claim 24, further comprising verifying decryption in accordance with a flag included in the secondary indexing information.

28. An apparatus for ciphertext searching, comprising:
a primary search unit configured to search on a primary index for a matching primary index item according to a primary index item identifier and transmit a ciphertext of primary indexing information in the primary index item; and
a secondary search unit configured to search on a secondary index for a matching secondary index item according to a secondary index item identifier and transmit a ciphertext of secondary indexing information in the secondary index item.

29. The apparatus according to claim 28, further comprising:
an updating unit configured to receive a secondary index item identifier and a ciphertext of secondary indexing information and use the received ciphertext of secondary indexing information to update secondary indexing information in a secondary index item having the same secondary index item identifier as the received secondary index item identifier.

30. A method for ciphertext searching, comprising:
searching on a primary index for a matching primary index item according to a primary index item identifier;
transmitting a ciphertext of primary indexing information in the primary index item;
searching on a secondary index for a matching secondary index item according to a secondary index item identifier; and
transmitting a ciphertext of secondary indexing information in the secondary index item.

31. The method according to claim 30, further comprising:
receiving a secondary index item identifier and a ciphertext of secondary indexing information;
searching for a secondary index item having the received secondary index item identifier; and
updating the secondary index item with the received ciphertext of secondary indexing information.
